(19) United States
(12) Patent Application Publication
(10) Pub. No.: US 2008/0319983 A1
(43) Pub. Date: Dec. 25, 2008

(54) METHOD AND APPARATUS FOR IDENTIFYING AND RESOLVING CONFLICTING DATA RECORDS

(76) Inventor: Robert Meadows, Las Vegas, NV (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/106,242

(22) Filed: Apr. 18, 2008

Related U.S. Application Data
(60) Provisional application No. 60/912,990, filed on Apr. 20, 2007.

(51) Int. Cl. G06F 7/20; G06F 17/30

(52) U.S. Cl. 707/5; 707/E17.014

(57) ABSTRACT

A method and apparatus for identifying and resolving conflicting data records are disclosed. The individual data fields of a master record are compared with the corresponding data fields of each source record in a particular data set. For each, one of various matching algorithms is used to assign a field matching score indicating the extent to which the data in the two data fields matches. The particular algorithm used to determine the extent of a match and to assign the corresponding score is dependent on the type of the data field. Once all of the data fields for a particular source record have been analyzed, the sum of the field matching scores is tallied to determine an overall record matching score for that particular source record.

### RELATED APPLICATIONS

This application is a nonprovisional of, incorporates by reference and claims the priority benefit of U.S. Provisional Patent Application No. 60/912,990, filed 20 Apr. 2007, assigned to the assignee of the present invention.

### FIELD OF THE INVENTION

The invention generally relates to data synchronization techniques. More specifically, the invention relates to a method and apparatus for identifying duplicate and/or conflicting data records (e.g., contact information), and resolving issues related thereto.

### BACKGROUND

With the increasing popularity of portable, wireless devices (e.g., laptop computers, mobile phones, personal digital assistants (PDAs), handheld global positioning system (GPS) devices, and so on), users have an increased need to synchronize data. For instance, a user may store data—such as personal and/or business contact information—on a personal computer (PC) or on a server of a web-based service. It is often desirable to synchronize this data with data stored on a portable device, such that a copy of the data are available on the wireless device for access by the user when on the move. Similarly, a user may want to synchronize data so that data entered on a portable device is backed-up or archived at a centrally located device. As any one of several devices may be used to input data, it is often the case that data conflicts arise. For example, a user may utilize a portable device to input a new telephone number for one of his or her contacts, thereby creating a data conflict between the new telephone number (as entered at the portable device) and the previous telephone number (as stored on the centralized PC or web-based service).

In order to synchronize two data records of two data sets, it is first necessary to identify two data records that match or partially match, such that the data associated with each record can be analyzed to determine whether any conflicts exist with respect to its matching or partially matching counterpart. This process is generally referred to as “matching”.

One method of matching is to assign each data record a unique identifier, which is maintained with the data record at each device. Accordingly, two records are considered to match when they have the same identifier. However, it is not always the case that each user device supports the use of unique record identifiers. Many devices simply do not support unique record identifiers. Furthermore, many devices modify the record identifier when data items are added or deleted to a particular record, or field. When unique record identifiers are not implemented and assigned to each data record, a different method of identifying matching records and resolving conflicts is required.

### SUMMARY OF THE INVENTION

Consistent with an embodiment of the present invention, each data field of a master record is compared with a corresponding data field of a source record. Depending upon the type of the field, various algorithms are used to assign points (e.g., a field matching score) indicating the extent to which the data in the two data fields match. For example, a field used to store a telephone number may be analyzed with a flexible matching algorithm, such that variations in the different conventions used for displaying and dialing telephone numbers (e.g., area codes, country codes, addition of a “1” or “+”) are taken into consideration when assigning the field matching score indicating the extent of the match between telephone numbers in two fields. Other fields, such as a field used to store a person's name, may be analyzed with a more rigid algorithm, such as an exact matching algorithm. For instance—as the name suggests—an exact matching algorithm may assign a score only when the data in two fields matches exactly. In one embodiment of the invention, a flexible matching algorithm is used after an exact matching algorithm fails to identify an exact match. Accordingly, the number of points assigned for an exact match may be higher than the number of points assigned for a flexible match, depending upon the field type.

After the fields of the master record have been compared with corresponding fields of a source record, the individual field matching scores for each pair of fields analyzed are summed to arrive at a record matching score for the source record. Once the matching analysis has been completed for each source record and each source record has been assigned a record matching score, the source record with the highest record matching score is identified. Before determining that the source record with the highest record matching score is a match of a particular master record, the source record is analyzed to determine if it meets a few other conditions. For instance, in one embodiment of the invention, the source record with the highest record matching score is determined to be a match only when the record matching score exceeds a predetermined threshold score, and/or a predetermined percentage of the source record's fields are determined to be matches. Other aspects of the invention are described below.

In various embodiments of the present invention, a first set of records is compared with a second set of records by selecting a first record from the first set of records, comparing the first record with each record in the second set of records, assigning a score to each record in the second set of records based on the similarity between the first record and each record in the second set of records, and matching the first record to a second record from the second set of records based on the score. The first set of records may be stored on a first device and the second set of records may be stored on a second device. In a further embodiment, the second set of records may be copied to the first device before comparing the first record with each record in the second set of records. The first record and the second record may be merged to create a third record. The first record and the second record may then be replaced by the third record.

The comparison of the first record with each record in the second set of records may include comparing data stored in each field of the first record with data stored in a corresponding field of each record in the second set of records and assigning a score to each record in the second set of records comprises assigning a score to each field in the second record. In one embodiment, a score may be assigned only if data stored in a predetermined field of the first record is identical to data stored in the predetermined field of each record from the second set of records.

The second record may be the record from the second set of records with the highest score. Alternatively, the second record may be a record from the second set of records with the highest score that has exceeded a predetermined threshold. The first record may be compared to each record in the second set of records using a plurality of algorithms such as, for example, a flexible matching algorithm.

In further embodiments, a first data set is synchronized with a second data set by selecting a first record from the first data set, selecting a selected record from the second data set, comparing data stored in the first record with data stored in the selected record, assigning a score to the selected record based on the similarity between the first record and the selected record, and if the score exceeds a predetermined threshold, matching the first record with the selected record.

In still another embodiment of the invention, if the score does not exceed a predetermined threshold, repeating the steps of selecting a selected record from the second data set, comparing data stored in the first record with data stored in the selected record, assigning a score to the selected record based on the similarity between the first record and the selected record, and if the score exceeds a predetermined threshold, matching the first record with the selected record until a score exceeds the predetermined threshold or all records in the second data set have been selected.

In yet a further embodiment of the invention, the first data set and the second data set are stored in different devices. Alternatively, the first data set and the second data set may be stored on the same device. The first data set may be stored on a portable device.

The first data set and the second data set may be databases such as, for example, contact information databases which store contact information for a plurality of individuals or entities.

The comparison of the data stored in the first record with data stored in the selected record may be accomplished by executing a flexible matching algorithm which creates a score based on the number of similar characters in a field within the first record and the selected record. The flexible matching algorithm may increase a score with extra points if an exact match is found between data stored in the first record and data stored in the selected record.

The comparison of data stored in the first record with data stored in the selected record may be accomplished by executing an exact matching algorithm which creates a score based on the number of fields that match exactly between the data stored in the first record and the data stored in the selected record.

The comparison of data stored in the first record with data stored in the selected record may be accomplished by comparing only data stored in predetermined fields.

The comparison of data stored in the first record with data stored in the selected record may be accomplished by comparing data stored in each field of the first record with data stored in each corresponding field of the second record and assigning a score to the selected record based on the similarity between the data stored in each field of the first record and the data stored in corresponding field in the selected record.

In still another embodiment, conflicts between a first database and a second database are resolved by matching the fields of the first database to the fields of the second database, comparing the data stored in each field of a first record from the first database to data stored in the matching field in each record of the second database, generating a score for each field in each record of the second database based on the correlation between the data stored in each field of the first record to data stored in the matching field in each record of the second database, generating a total score for each record in the second database based on the score for each field in each record, labeling the record from the second database with the highest score the closest record, and if the highest score is above a predetermined threshold, matching the closest record to the first record.

These and further details of the present invention are discussed in detail below.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 illustrates a variety of end user devices, which may be configured to operate with and synchronize data stored at a network- or web-based data server, according to an embodiment of the invention;

FIG. 2 illustrates an example of a data record with several data fields, according to an embodiment of the invention;

FIG. 3 illustrates a method, according to an embodiment of the invention, for assigning a record matching score to a source data record; and

FIGS. 4 through 8 illustrate examples of how field matching scores and record matching scores are calculated according to one embodiment of the invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts. Although discussed with reference to these illustrations, the present invention is not limited to the implementations illustrated therein. Hence, the reader should regard these illustrations merely as examples of embodiments of the present invention, the full scope of which is measured only in terms of the claims following this description.

As presented herein, the invention is described in the context of a contact management application—for example, an application used to enter, store and manage personal and/or business contact information on one or more user devices. However, the present invention should not be construed as being limited to this context. Those skilled in the art will appreciate that the present invention is applicable in a wide variety of other contexts as well, particularly in those contexts involving record synchronization.

Consistent with one embodiment of the invention, an apparatus and method for identifying and resolving conflicting data records are provided. Accordingly, the first step in such a method involves determining if there is a source record that matches a master record, and if so, identifying the matching source record. As used herein, a master data record, or master record, is a record that is stored at a centralized data source (e.g., the master device). For instance, the centralized data source may be the database of an application executing and residing on a user's personal computer. Alternatively, the centralized data source may be the database of a network- or web-based data service. Similarly, a source record is a record associated with or stored on an end user device, such as a wireless mobile phone, personal digital assistant, laptop, global positioning device, or any like kind device.

In one embodiment of the invention, the matching process is accomplished by comparing the individual data fields of a master record with the corresponding data fields of each source record in a particular data set. For each data field, one of various matching algorithms is used to assign a field matching score indicating the extent to which the data in the two data fields matches. The particular algorithm used to determine the extent of a match and to assign the corresponding score is dependent on the type of the data field.

Once all of the data fields for a particular source record have been analyzed, the sum of the field matching scores is tallied to determine an overall record matching score for that particular source record. After a record matching score for each source record is determined, the source record with the highest record matching score is analyzed to determine if it meets all of the conditions to be considered a match of the master record. In one embodiment, the source record with the highest matching score is considered a match only if the record matching score exceeds a threshold score and/or a predetermined percentage of the individual fields are considered to match, as determined by the individual algorithms used to analyze the fields. In addition, the number of field conflicts must be equal to or less than a predetermined number in order for the source record to be considered a match in one embodiment of the invention. A field conflict exists where both the master and source records include data, and the data do not match under an exact of flexible matching algorithm. Various other aspects of the invention are described below in connection with the description of the figures.

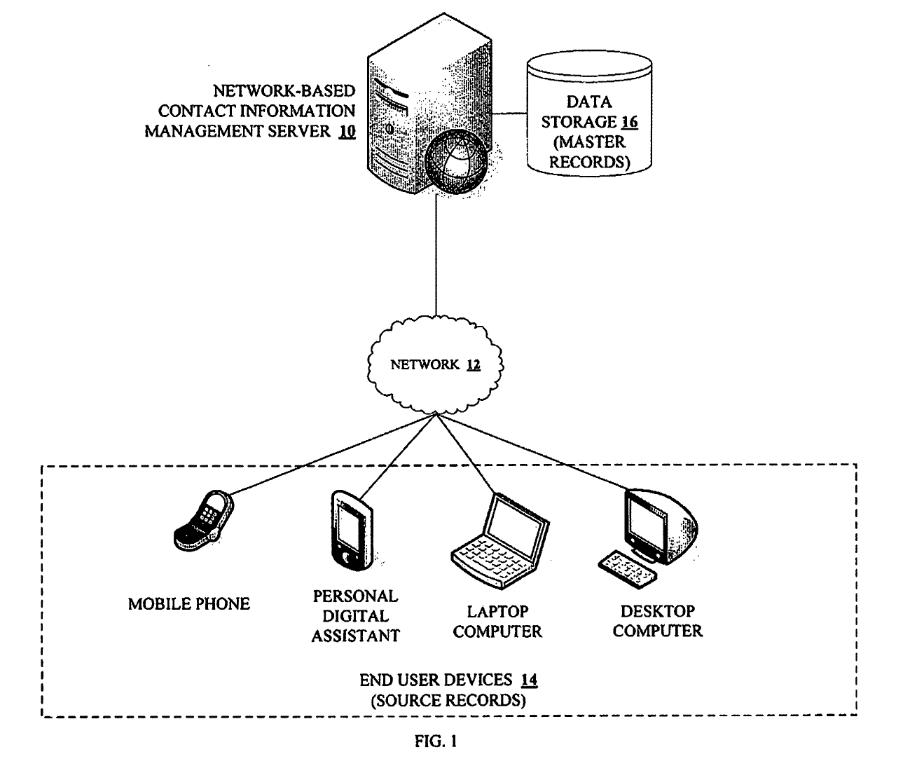

FIG. 1 illustrates a variety of end user devices, which may be configured to operate with, and synchronize data stored at, a network-based data service, according to an embodiment of the invention. As illustrated in FIG. 1, a network-based contact information management server 10 is configured to provide a data service over a network 12 to a variety of end user devices 14. In this case, the contact information management server 10 is a master device, while each end user device is a source device. Accordingly, the records associated with and stored at the contact information management server are considered to be master records, while the records associated with and stored at each client device are source records. In one embodiment of the invention, the contact information management server 10 is coupled to one or more data storage devices 16, where it stores the master records.

Generally, a user will interact with one or more end user devices by entering various information, such as contact information for personal and/or business contacts. On occasion, a synchronization process will be initiated (e.g., either automatically, or manually), and the contact information stored at a particular end user device will be synchronized with the contact information stored at the contact information management server 10.

In one embodiment of the invention, the matching analysis and the conflict resolution analysis occurs at the master device (e.g., the contact information management server 10). Accordingly, during the synchronization process the source records are communicated from an end-user device to the contact information management server 10 over the network 12. In an alternative embodiment, the matching and conflict resolution analysis may occur on the end user device. In this case, the master records are communicated from the contact information management server 10 to the end user device. Furthermore, in one embodiment of the invention, multiple synchronization modes may be supported, such that a user may perform a full synchronization, in which case all source records are communicated to the master device, or a partial synchronization, in which case only records which have been modified since the last synchronization process was performed are communicated to the master device.

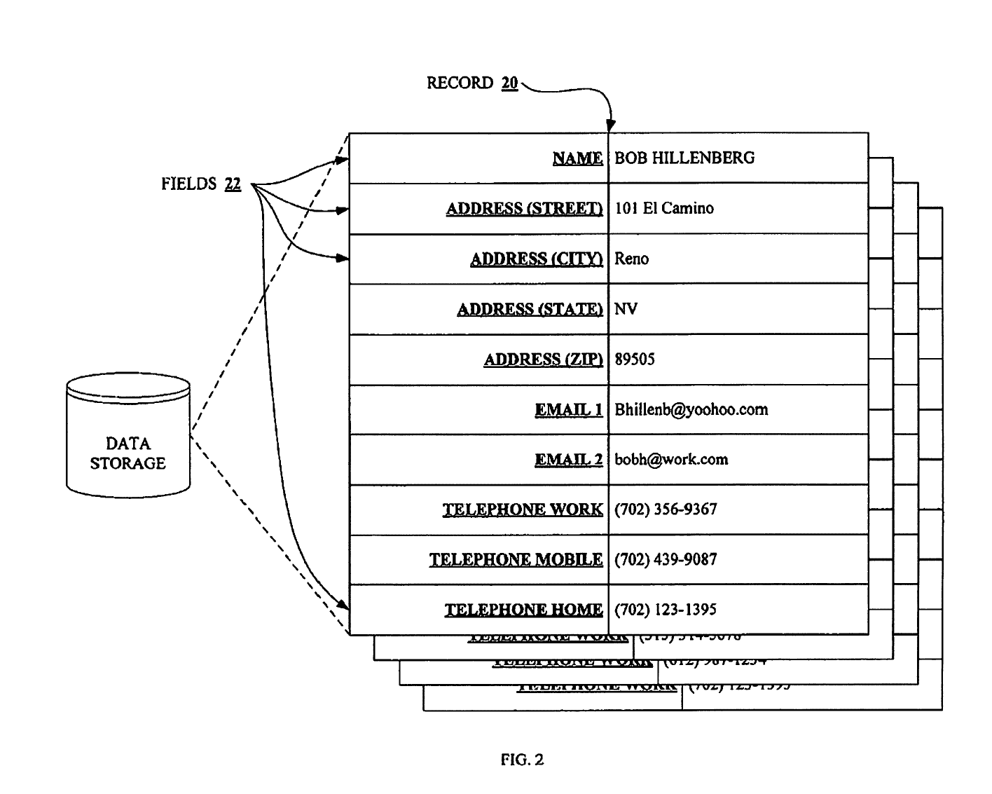

FIG. 2 illustrates an example of a data record 20 with several data fields 22, according to an embodiment of the invention. For example, the data record 20 illustrated in FIG. 2 has a field for a name, several fields for an address, two individual fields for email addresses, and three fields for telephone numbers. Accordingly, the field types for the various fields illustrated in FIG. 2 are NAME, ADDRESS, EMAIL, and TELEPHONE NUMBER. Those skilled in the art will appreciate that various devices and software applications support a wide variety of different fields, and field types. Accordingly, the present invention should not be construed to be limited by the field types illustrated in FIG. 2.

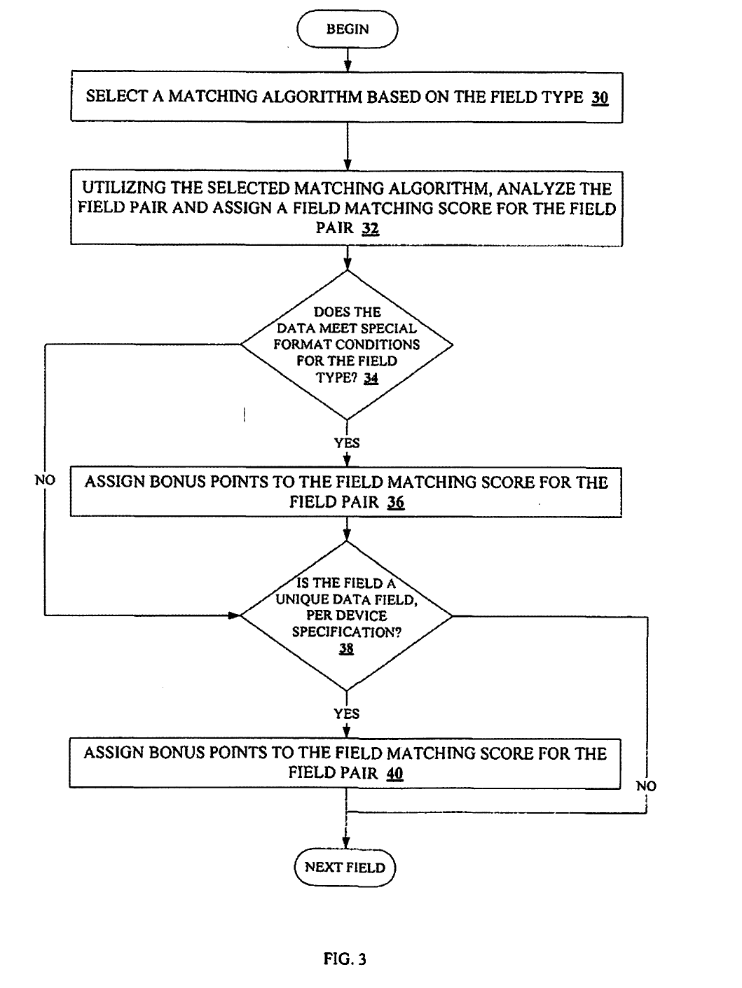

FIG. 3 illustrates a method, according to an embodiment of the invention, for assigning a record matching score to a source data record. The method begins at operation 30 where the first field to be analyzed is identified, and its field type is determined. Based on the field type, a particular matching algorithm is selected. Then, at operation 32, the selected matching algorithm is used to analyze the field pair and determine the extent to which the field pair (e.g., a first field from the master record, and a second field from a source record) match. Depending on the particular field type and the extent of the match as determined by the selected matching algorithm, a field matching score is assigned to the field pair.

In general, the particular algorithms used to analyze the fields can be separated into two categories—flexible matching algorithms, and exact matching algorithms. As the name suggests, an exact matching algorithm analyzes the data in a field pair to determine whether it matches exactly in terms of characters and case (e.g., upper and/or lower case). In contrast, a flexible matching algorithm looks for similarities in the data without requiring an exact match. For instance, a flexible matching algorithm used to analyze a NAME field may take into account that one field may include a first name, whereas its counterpart may include both a first and last name. Similarly, under a flexible matching algorithm, two fields may match even when one field includes a title prefix, such as “Mr .”, “Mrs.”, “Ms.”, or “Dr.”. In addition, flexible matching algorithms may account for differences in the case (e.g., upper or lower case) of characters. With a TELEPHONE NUMBER field, a flexible matching algorithm may take into account differences in the format of a telephone number. For instance, a flexible matching algorithm may take into account that two telephone numbers may differ due to the inclusion of an area code, a country code, a “1” or a “+” before the number. A flexible matching algorithm for a GENDER field may simply analyze the first letter of the gender such that “Male” is a match for “m”, and “female” is a match for “F”. Depending upon the particular embodiment, the particular algorithm used to analyze a field pair may include a combination of algorithms, for example, such that an exact match is attempted first. If not exact match can be found, a particular type of flexible match be made, and so on, until some type of match is made, or no match is made.

Referring again to FIG. 3, at operation 32 a field matching score is assigned to the field pair (assuming a match has been made). For instance, if the field pair do not match, the field matching score is zero. However, if the field pair match, a positive score is assigned to the field pair. The actual number of points assigned depends on the field type and the algorithm used to determine the extent of the match. In general, fields that match exactly are assigned a greater number of points than fields that match under a flexible matching algorithm. For instance, with a TELEPHONE NUMBER field, more points may be assigned if the two telephone numbers match exactly than if the telephone numbers differ because of a missing area code. Some field types, such as NAME, TELEPHONE NUMBER, and EMAIL tend to uniquely identify a person, and are therefore allocated more points when a match occurs. On the other hand, because certain field types are not particularly suggestive of a record match, those field types may be assigned fewer points when the field data match. For example, a GENDER field provides little information in determining whether two records are a match. Accordingly, in one embodiment of the invention, the field matching score for a GENDER field may be minimal—one or two points.

In one embodiment of the invention, certain field types may be given additional points if the data meet certain conditions. Accordingly, as illustrated in FIG. 3, at operation 34 the data are analyzed to determine whether they meet certain formatting conditions. If the data meet the formatting conditions, at operation 36 additional points are allocated to the field matching score for the field pair. For example, in one embodiment, additional points may be assigned to a particular field when the data match exactly and the length of the data is greater than or equal to a predetermined threshold. For instance, with a NAME field, if two names match and the names are sufficiently long, the likelihood of a record match is greater. Similarly, additional points may be allocated when two names match and there is a space between the first name and the last name, indicating a valid first and last name.

Extra points may be allocated to the field matching score of a field pair when the field is a unique field. For example, certain devices may require that a particular field, like a NAME field, not have any duplicate data entries. In one embodiment of the invention, each device includes configuration information that indicates different attributes associated with the data fields supported by the device. Accordingly, the configuration information may specify that a particular field is a unique field. Therefore, if a unique field pair is an exact match, there is a higher likelihood that the records match. Accordingly, at operation 38 the field attributes are analyzed to determine whether the field type is unique for the particular user device. At operation 40, additional points are allocated to the field matching score if the data match and the field type is unique.

After the field matching score has been allocated for each data field in a source record, the field matching scores are summed to arrive at a record matching score for the source record. Once this is done for each source record, the source record that has the highest record matching score for a particular master record is paired with that master record. However, in one embodiment, the source record with the highest record matching score is matched with a master record only when the record matching score exceeds a predetermined threshold score and/or a minimum number or percentage of the fields for the source record match those of the master record. Furthermore, in one embodiment of the invention, the source record with the highest record matching score must have less than a predetermined number of field collisions with the master record, where a field collision exists when both the master and source record have data for a particular field and the data do not match under an exact or flexible matching algorithm.

After the master records have been paired with the source records based on the matching process as defined above, a conflict resolution routine is executed. In one embodiment of the invention, the conflict resolution routine merges two different records into a single record that is stored in both the source (end user device) and the master device (e.g., the contact information management server database 16). For each record with conflicting data fields, any data field of the source record that contains data that do not match its counterpart in the master record is copied to the corresponding data field of the master record. Similarly, each data field in the master record that contains data that does not match the source data is deleted from the master record. That is, when the master record has data in a particular field, and the corresponding field of the source record does not have data, the data in the field of the master record is deleted.

As described briefly above, the matching and conflict resolution analysis may occur at either the master device, or alternatively, at the source device. In an embodiment of the invention wherein the analysis occurs at a master device, the individual routines and algorithms are generally implemented as computer applications that execute on the master device. Accordingly, one embodiment of the invention is implemented as a series or set of machine- or computer-readable instructions. Accordingly, when the instructions are executed by a machine or computer, the various routines, process and algorithms described above are carried out.

In one embodiment of the invention, an application for synchronizing data records may have a graphical or command line user interface, by which various configuration parameters may be set. Accordingly, the matching process can be fine tuned by adjusting the configuration parameters on an on going basis. Below are listed a set of configuration parameters which may be established, according to one embodiment of the invention:

### NORMAL_SCORE_FIELD_POINTS=2

This parameter establishes the default score (e.g., 2 points) assigned for a flexible match when the particular field under consideration is not considered a special field.

### SPECIAL_SCORE_FIELDS=NAME, EMAIL, PHONE_CELL, PHONE_PAGER

This parameter indicates the data fields that receive special scores when the data in those fields match under a flexible matching algorithm.

### SPECIAL_SCORE_FIELD_POINTS=9, 10, 10, 10

This parameter establishes the field matching score (e.g., amount of points) that each special field should receive for a flexible match. In this example, a NAME field with a flexible match would receive 9 points, whereas the EMAIL, PHONE_CELL, PHONE_PAGER fields would each receive 10 points for a flexible match.

### EXACT_MATCH BONUS_SCORE_FIELDS=NAME, PHONE WORK, PHONE_HOME, PHONE_FAX, PHONE_VOICE, PHONE_CELL, PHONE_PAGER, PHONE_GENERIC, PHONE_OTHER

The EXACT_MATCH_BONUS_SCORE_FIELDS is a parameter that establishes the special fields that receive bonus points if the data of the field pair contains an exact match. For instance, in this example, bonus points would be assigned if the names in a source and master field match exactly.

### EXACT_MATCH_BONUS_SCORE_FIELD_POINTS=2, 1, 1, 1, 1, 1, 1, 1, 1

This parameter establishes the bonus (e.g., amount of points) that each special field should receive for an exact match. In this example, a NAME field with an exact match receives two bonus points, whereas an exact match in the other fields counts for one additional bonus point.

### EXACT_MATCH_BONUS_MIN_FIELD_LENGTH=5, 3, 3, 3, 3, 3, 3, 3, 3

This parameter establishes a minimum length that the data in a particular field must be to receive the bonus points for an exact match. For instance, in this example, bonus points are only assigned for a NAME field when an exact match occurs and the length of the name is more than five characters. Thus, a match for the name “Bob” would not receive bonus points, but a match for the name “Lakeisha” would receive bonus points.

### EXACT_MATCH_BONUS_REQUIRED_FIELD_CHARS=“”, “”, “”, “”, “”, “”, “”, “”, “”

This parameter provides a list of characters that each field must contain to receive the exact match bonus points. In this particular example, note that the first item in the list (for the field NAME) contains a space. The other fields contain the empty string and thus do not require any special characters.

### UNIQUE_BONUS_SCORE_FIELDS=NAME

As described in detail above, certain end user devices may support unique fields. For synchronization end-points that support unique fields, the UNIQUE_BONUS_SCORE_FIELDS parameter indicates which fields are unique. For example, many Motorola phones use the contact name as the unique index.

### UNIQUE_BONUS_SCORE_FIELD_POINTS=2

This parameter establishes the number of bonus points to assign when there is an exact match for a unique field, assuming the device involved supports unique fields.

### SCORE_MATCH_THRESHOLD_SCORE=11

This parameter sets a minimum threshold in terms of total points (e.g., a record matching score) in order for a master record and a source record to be considered a match. A score of −1 indicates that this criteria should not be used (and instead use the percentage threshold).

### SCORE_MATCH_THRESHOLD_PERCENT=0.90

This parameter defines the minimum threshold in terms of the percentage of field pairs that must have a flexible match in order for a match to be declared. This percentage is calculated by dividing the record matching score (e.g., the sum of all field matching scores) by the total possible score. When either the source record or master record do not contain a value for a particular field, this is not considered in the total possible score. For instance only fields with existing valid data are considered.

### SCORE_MINIMUM_COMMON_FIELDS_FOR_PERCENT_MATCH=2

This parameter represents the minimum number of fields that each record pair must have values for to be considered for a percentage match. For example, two potential matches would both need fields like name and cell number defined to qualify. If both had name fields defined, and one just had a work number, and the other just an email address, these records would not meet this criteria.

### SCORE_MAX_CONFLICTS=1

This parameter represents the maximum allowable number of conflicting fields before two records are considered not to match. For instance, if two records have NAME fields that match exactly, but the PHONE_WORK and PHONE_HOME fields conflict, then in this example where SCORE_MAX_CONFLICTS is equal to one, the records would not qualify as a match.

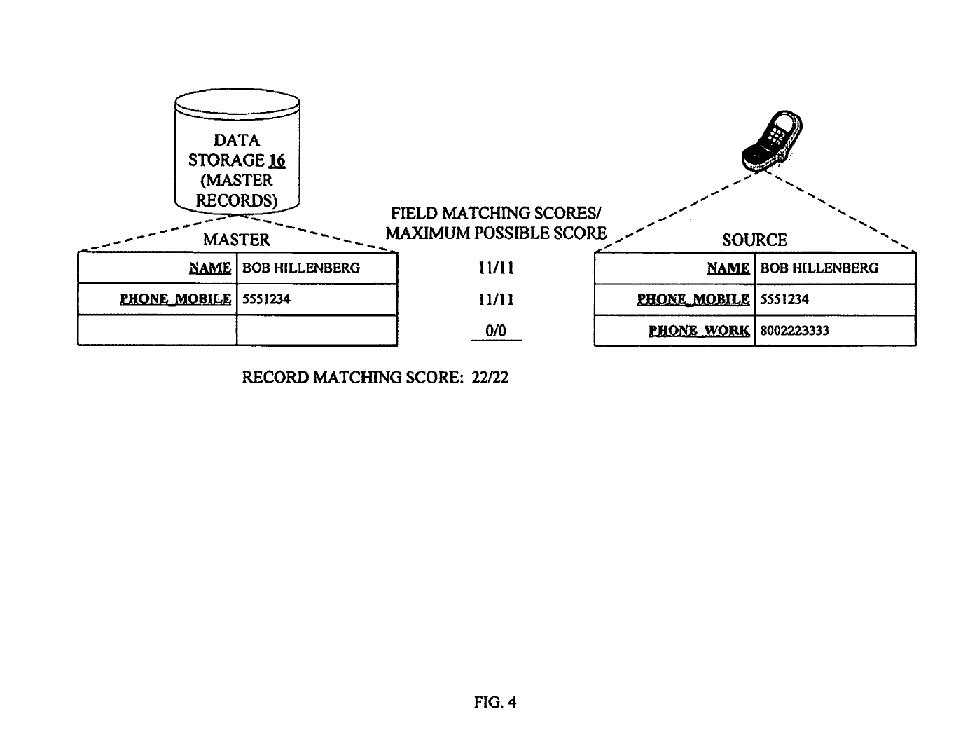

FIGS. 4 through 8 provide examples of how field matching scores and record matching scores are calculated in accordance with the example configuration parameters set forth above. As illustrated in FIG. 4, two records—a master record and a source record—have data in a varying number of fields. For instance, the master record has data for only two fields, while the source record has data defined for a third field, PHONE_WORK. The field matching score for the NAME field is eleven, calculated as follows. Because the data in the fields are a flexible match, nine points are allocated. In addition, two bonus points for an exact match are allocated. Accordingly, the NAME field is allocated eleven out of eleven total possible points. The PHONE_MOBILE field is allocated ten points for a flexible match, and an additional one point for an exact match. Thus, the PHONE_MOBILE field is allocated eleven out of eleven possible points. Finally, the PHONE_WORK field does not have data in the master record, and is therefore not counted in tallying the record matching score. Accordingly, the record matching score for the source record is twenty-two out of a possible twenty-two points. Given a threshold score of eleven points, the records are determined to be a match.

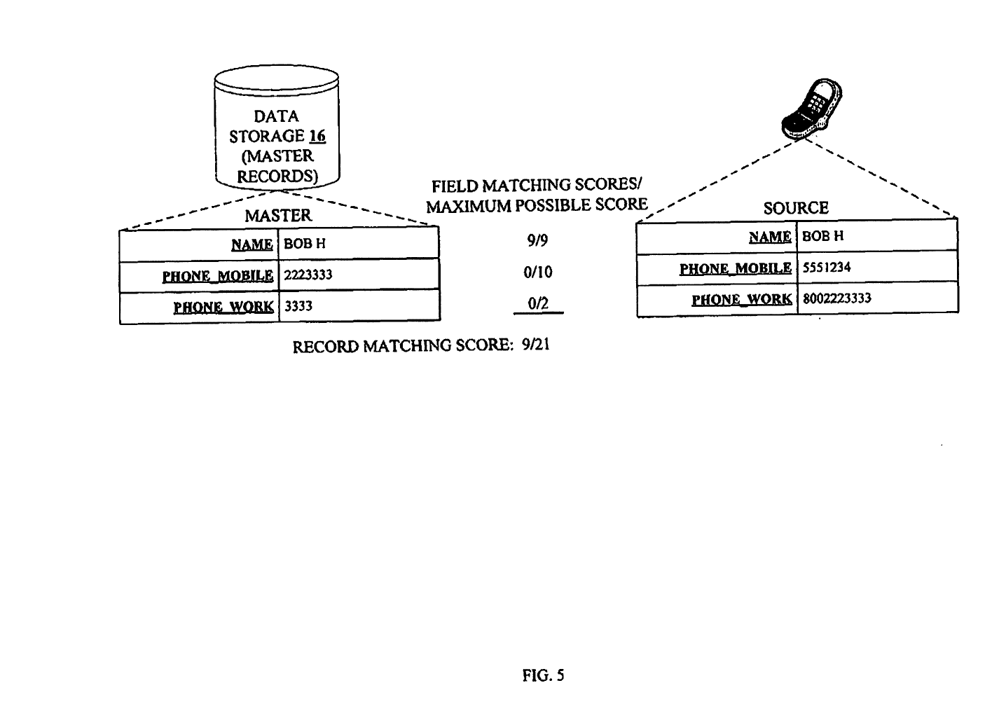

In the example illustrated in FIG. 5, the record matching score is nine out of a possible twenty-one points, calculated as follows. The NAME field is allocated nine out of a possible nine points for a flexible match. Although the names are literally an exact match, no bonus points are allocated under the exact matching algorithm as the length of the name does not meet the minimum required length (e.g., greater than five characters) for receiving points under an exact match. The data in the PHONE_MOBILE fields does not match, and therefore the field is actually counted as a conflicting field. The data in the PHONE_WORK fields do not match, and therefore the field is also counted as a conflict. Accordingly, the record matching score does not exceed the threshold (e.g., eleven points), and therefore the source record is not determined to match the master record. Furthermore, with two conflicting fields, the number of conflicts exceeds the minimum allowable number.

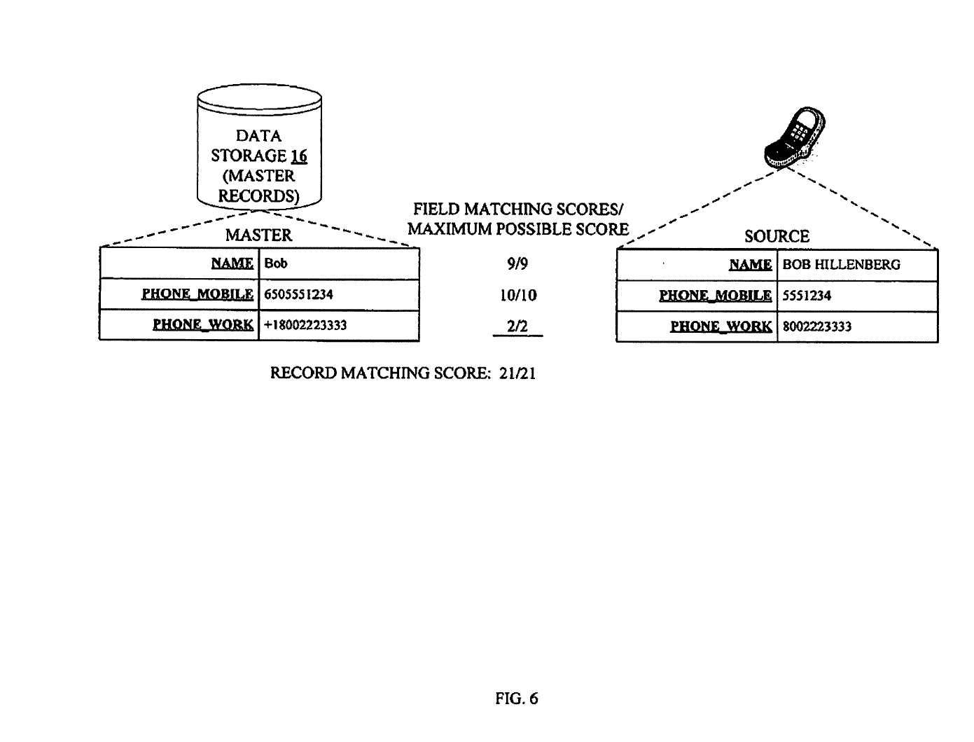

In the example illustrated in FIG. 6, all fields match and the record matching score is a perfect twenty-one out of twenty-one. The NAME field is allocated nine points for a flexible match, but no bonus points for an exact match. The PHONE_MOBILE field is allocated ten points for a flexible match, but no extra points for an exact match. The PHONE_WORK field is allocated two points for a flexible match, but no additional points for an exact match. Consequently, the record matching score is twenty-one, and the source record is determined to match the master record.

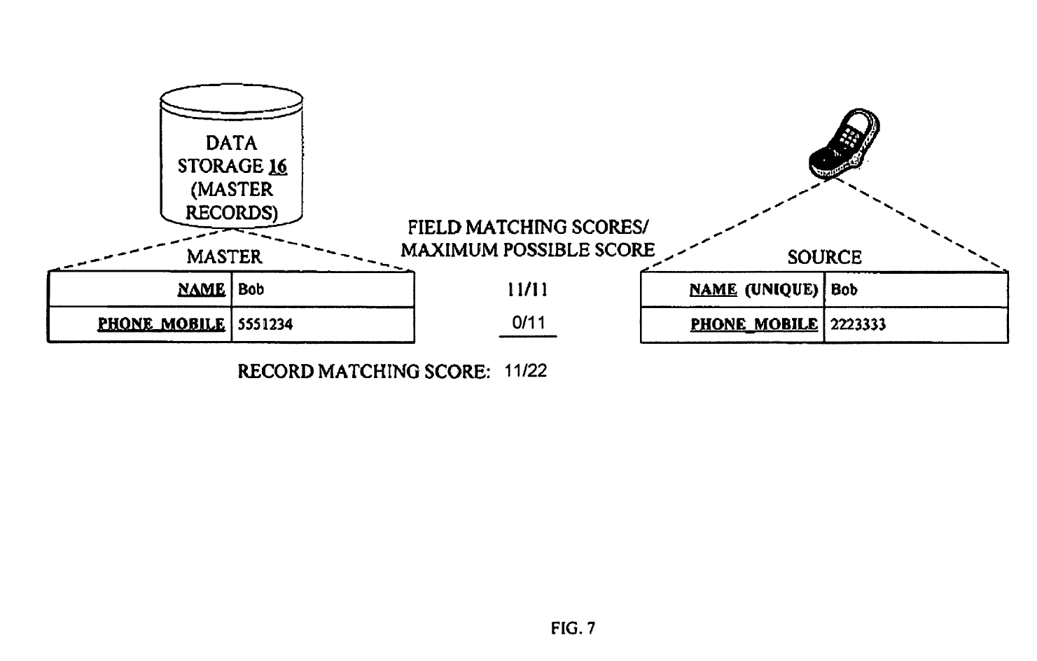

In the final example illustrated in FIG. 7, the record matching score for the source record is eleven, calculated as follows. The NAME field is allocated nine points for a flexible match, and two additional bonus points for being a unique field. The PHONE_MOBILE field is not a match, and is allocated zero points of a possible ten. Consequently, the record matching score is eleven of twenty-one total possible points, which meets the threshold. Accordingly, the records are deemed to match.

The foregoing description of various implementations of the invention has been presented for purposes of illustration and description. It is not exhaustive and does not limit the invention to the precise form or forms disclosed. Furthermore, it will be appreciated by those skilled in the art that the present invention may find practical application in a variety of alternative contexts that have not explicitly been addressed herein. Finally, the illustrative processing steps performed by a computer-implemented program (e.g., instructions) may be executed simultaneously, or in a different order than described above, and additional processing steps may be incorporated. The invention may be implemented in hardware, software, or a combination thereof. When implemented partly in software, the invention may be embodied as instructions stored on a computer- or machine-readable medium. In general, the scope of the invention is defined by the claims and their equivalents.

What is claimed is:

1. A method of comparing a first set of records to a second set of records comprising:
(a) selecting a first record from the first set of records;
(b) comparing the first record with each record in the second set of records;
(c) assigning a score to each record in the second set of records based on the similarity between the first record and each record in the second set of records; and
(d) matching the first record to a second record from the second set of records based on the score.

2. The method of claim 1 wherein the first set of records is stored on a first device and the second set of records is stored on the second device.

3. The method of claim 2 further comprising copying the second set of records to the first device before comparing the first record with each record in the second set of records.

4. The method of claim 1 further comprising merging the first record and the second record to create a third record.

5. The method of claim 4 further comprising replacing the first record and the second record with the third record.

6. The method of claim 1 wherein comparing the first record with each record in the second set of records comprises comparing data stored in each field of the first record with data stored in a corresponding field of each record in the second set of records and assigning a score to each record in the second set of records comprises assigning a score to each field in the second record.

7. The method of claim 6 wherein a score is assigned only if data stored in a predetermined field of the first record is identical to data stored in the predetermined field of each record from the second set of records.

8. The method of claim 1 wherein the second record is a record from the second set of records with the highest score.

9. The method of claim 1 wherein the second record is a record from the second set of records with the highest score that has exceeded a predetermined threshold.

10. The method of claim 1 wherein a flexible matching algorithm is used to compare the first record with each record in the second set of records.

11. A method of synchronizing a first data set with a second data set comprising:
(a) selecting a first record from the first data set;
(b) selecting a selected record from the second data set;
(c) comparing data stored in the first record with data stored in the selected record;
(d) assigning a score to the selected record based on the similarity between the first record and the selected record; and
(e) if the score exceeds a predetermined threshold, matching the first record with the selected record.

12. The method of claim 11 further wherein if the score does not exceed a predetermined threshold, repeating the steps (b) through (e) until:
(i) a score exceeds the predetermined threshold or
(ii) all records in the second data set have been selected.

13. The method of claim 11 wherein the first data set and the second data set are stored in different devices.

14. The method of claim 13 wherein the first data set is stored on a portable device.

15. The method of claim 11 wherein the first data set and the second data set are contact information databases.

16. The method of claim 11 wherein the comparing data stored in the first record with data stored in the selected record comprises executing a flexible matching algorithm which creates a score based on the number of similar characters in a field within the first record and the selected record.

17. The method of claim 16 wherein the flexible matching algorithm increases a score with extra points if an exact match is found between data stored in the first record and data stored in the selected record.

18. The method of claim 11 wherein comparing data stored in the first record with data stored in the selected record comprises executing an exact matching algorithm which creates a score based on the number of fields that match exactly between the data stored in the first record and the data stored in the selected record.

19. The method of claim 11 wherein comparing data stored in the first record with data stored in the selected record comprises comparing only data stored in predetermined fields.

20. The method of claim 11 wherein comparing data stored in the first record with data stored in the selected record comprises comparing data stored in each field of the first record with data stored in each corresponding field of the second record and assigning a score to the selected record based on the similarity between the data stored in each field of the first record and the data stored in corresponding field in the selected record.

21. A method for resolving conflicts between a first database and a second database, the method comprising:
(a) matching the fields of the first database to the fields of the second database;
(b) comparing the data stored in each field of a first record from the first database to data stored in the matching field in each record of the second database;
(c) generating a score for each field in each record of the second database based on the correlation between the data stored in each field of the first record to data stored in the matching field in each record of the second database;
(d) generating a total score for each record in the second database based on the score for each field in each record;
(e) labeling the record from the second database with the highest score the closest record; and
(f) if the highest score is above a predetermined threshold, matching the closest record to the first record.
